(19) United States
(12) Patent Application Publication
(10) Pub. No.: US 2013/0257746 A1
(43) Pub. Date: Oct. 3, 2013

(54) Input Module for First Input and Second Input

(71) Applicants: Dmitriy Sergeyevich Cherkasov, San Jose, CA (US); John P. McCarthy, Pleasanton, CA (US)

(72) Inventors: Dmitriy Sergeyevich Cherkasov, San Jose, CA (US); John P. McCarthy, Pleasanton, CA (US)

(21) Appl. No.: 13/434,550

(22) Filed: Mar. 29, 2012

(51) Int. Cl. G06F 3/041

(52) U.S. Cl. 345/173

(57) ABSTRACT

Examples disclose an input device with an input module to reposition along an axis, a first input sensor to detect the input module reposition from a hand gesture and a second input sensor to detect a touch gesture at a surface of the input module. A first input signal for a computing device is received if the input module is repositioned and a second input signal for the computing device is received if the second input sensor detects the touch gesture.

### BACKGROUND

When interacting with a computing device, a user can access input components of the computing device, such as a keyboard and a mouse. A first hand can reposition the mouse for a first input and a second hand can access alphanumeric keys of the keyboard for a second input. The computing device can detect the first input and the second input from each separate input component to identify corresponding commands for the computing device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates an input device with an input module according to an example.

FIG. 2A and FIG. 2B illustrate an input module coupled to a first input sensor and a second input sensor according to an example.

FIG. 3A illustrates a block diagram of a controller receiving inputs for a computing device according to an example.

FIG. 3B illustrates a computing device executing input commands in response to a user accessing an input module according to an example.

FIG. 4 is a flow chart illustrating a method for detecting an input for a computing device according to an example.

FIG. 5 is a flow chart illustrating a method for detecting an input for a computing device according to another example.

### DETAILED DESCRIPTION

An input device includes an input module coupled to a chassis of the input device which can reposition along an axis. For the purposes of this application, the input module is a hardware component, which the user can reposition with a finger and/or hand movement. When repositioning, the input module can slide and/or pivot along one or more axes. In one embodiment, the input module includes a flat elongated top surface and is elevated above a surface of the chassis of the device. The chassis houses components of the device, such as a first input sensor and a second input sensor. The first input sensor can include a position sensor and/or a directional sensor which detects position data of the input module repositioning. A second input sensor coupled to the input module, such as a touch pad, detects touch data in response to a touch gesture being made at a top surface of the input module.

By accessing the input module for a first input and a second input, the user can conveniently use a single hand to enter one or more inputs for a computing device. If the first input sensor detects the input module being repositioned, the first input sensor can share the position data as a first input signal for a computing device. If the second input sensor detects a touch gesture at the surface of the input module, the second input sensor can share the touch data as a second input signal for the computing device. The first input signal and the second input signal are shared in parallel of one another.

Using the first input signal and the second input signal, the computing device can identify a first input command associated with the input module repositioning and the computing device can identify a second input command associated with the touch gesture. In one embodiment, the computing device can identify a combination input command associated with the information from the first input and the second input. As a result, a user friendly experience can be created for the user by providing the user the ability to conveniently enter one or more input commands for the computing device by accessing the input module with a gesture.

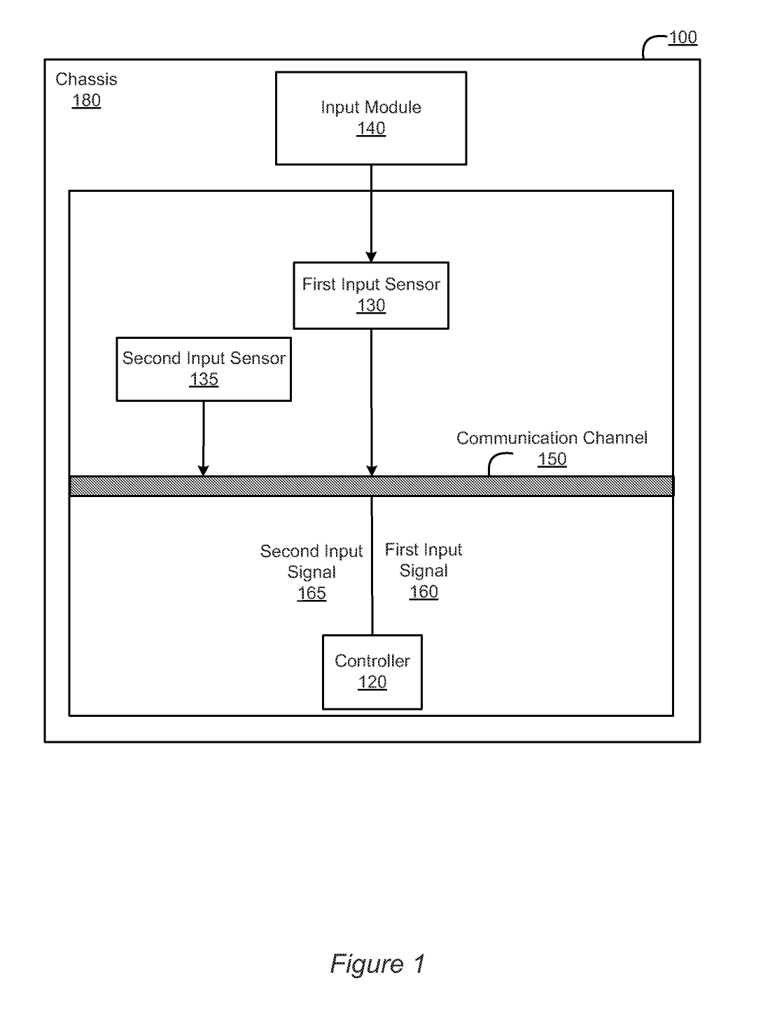

FIG. 1 illustrates an input device 100 with an input module 140 according to an example. For the purposes of this application, the input device 100 is an input component for a computing device. The input device 100 can be integrated as part of a computing device or the input device 100 can be a peripheral input component externally coupled to a port of a computing device. As illustrated in FIG. 1, the input device 100 includes a chassis 180, a controller 120, an input module 140, a first input sensor 130, a second input sensor 135, and a communication channel 150 for one or more components of the input device 100 to communicate with one another.

The chassis 180 is a frame, an enclosure, and/or a casing to house one or more components of the input device 100. For the purposes of this application, the input module 140 is a hardware component of the input device 100, such as a track pad, which is coupled to a surface of the chassis 180. In one embodiment, the input module 140 is couple to the chassis 180 through a mechanism which elevates the input module 140 to a position substantially parallel to the surface of the chassis 180. The mechanism is a hardware component, such as a control stick, which allows the input module 140 to reposition along one or more axis. An axis include an X, Y, and/or Z axis.

A first input sensor 130 of the input device 100, such as a position sensor and/or a potentiometer, can detect for the input module 140 repositioning in response to a user accessing the input module 140 with a hand gesture. The hand gesture can be made with a finger and/or hand of the user to reposition the input module 140 along an axis. In one embodiment, when repositioning along an X and/or Y axes, the input module 140 can pivot or slide laterally along the X and/or Y axes. Additionally, when repositioning along a Z axis, the input module 140 can reposition vertically. The first input sensor 130 can detect information of the input module 140 repositioning and share the information with the controller 120 as a first input signal 160. For the purposes of this application, the first input signal 160 includes data and/or information, such as position data, of the input module 140 repositioning.

A second input sensor 135 of the input device 100, such as a touchpad or a touch sensitive surface at a top surface of the input module 140, can detect for a touch gesture from the user. The touch gesture can be made with a finger of the user at the top surface of the input module 140. The second input sensor 135 can detect information of the touch gesture and share the information with the controller 120 as a second input signal 165. The second input signal 165 includes data and/or information, such as touch data, of a touch gesture detected at the surface of the input module 140. For the purposes of this application, the first input signal 160 is shared by the first input sensor 130 in parallel of the second input sensor 135 sharing the second input signal 165 with the controller 120.

The controller 120 may be any suitable controller and/or processor, such as a central processing unit (CPU), a semiconductor-based microprocessor, or any other device suitable for retrieval and execution of instructions. In one embodiment, the input device 100 includes logic in addition to and/or in lieu of the controller 120. In other embodiments, the controller 120 is an integrated circuit (IC) of the input device 100. The controller 120 is connected to the first input sensor 130 and the second input sensor 135 to receive the first input signal 160 and the second input signal 165 for a computing device. In one embodiment, the controller 120 receives the first input signal 160 and the second input signal 165 in parallel of one another. In another embodiment, the controller 120 receives the first input signal 160 and the second input signal 165 in sequence.

The computing device can be a laptop, a notebook, a tablet, a netbook, an all-in-one system, a desktop, a workstation, and/or a server. In another embodiment, the computing device can be a cellular device, a PDA (Personal Digital Assistant), an E (Electronic)-Reader and/or any additional computing device coupled to the device 100. The computing device can use information of the first input signal 160 and the information of the second input signal 165 to identify and execute one or more input commands for the computing device.

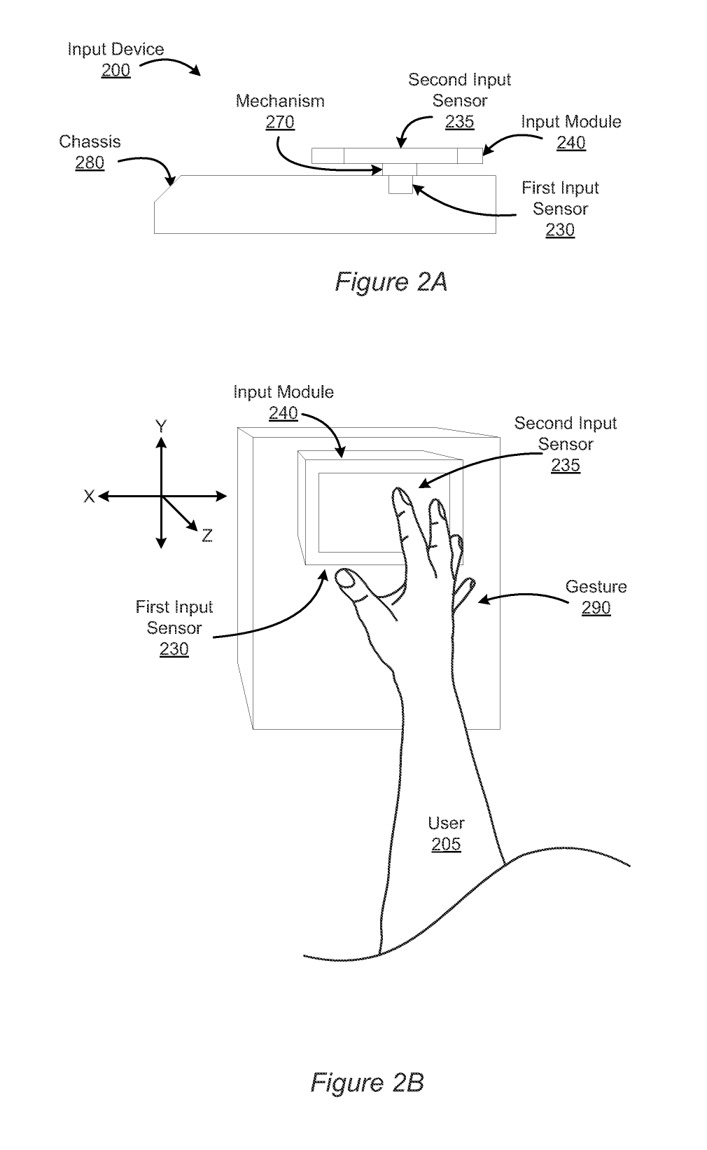

FIG. 2A and FIG. 2B illustrate an input module 240 coupled to a first input sensor 230 and a second input sensor 235 according to an example. As noted above, the input device 200 is an input component for a computing device. The input device 200 can be integrated as part of the computing device or the input device 200 can be a peripheral input component coupled to a port of the computing device. The chassis 280 of the device 200 can be a frame, an enclosure, and/or a casing to house one or more components of the input device 200. In one embodiment, if the input device 200 is integrated with a computing device, the chassis 280 of the input device 200 includes a chassis of the computing device. A composition of the chassis 280 can include an alloy, a plastic, a carbon fiber, a fiberglass, and/or any additional element or a combination of elements in addition to and/or in lieu of those noted above.

As shown in FIG. 2A, the input module 240 is coupled to a surface of the chassis 280 through a mechanism 270. For the purposes of this application, the mechanism 270 is a hardware component of the input device 200 which allows the input module 240 to reposition along one or more axes. In one embodiment, as shown in FIG. 2A, the mechanism 270 elevates the input module 240 above the chassis 280 to a position substantially parallel to a top surface of the chassis 280. The mechanism 270 can include a control stick to allow the input module 240 to pivot along one or more axes. The control stick can be an analog stick and/or a directional pad. In another embodiment, the mechanism 270 includes one or more rails for the input module 240 to laterally slide along one or more axes.

A first input sensor 230 is a hardware component of the input device 200 which detects information of the input module 240 repositioning along an axis. In one embodiment, the first input sensor 230 is coupled to the mechanism 270 to detect the input module 240 repositioning. The first input sensor 230 can include a potentiometer, a position sensor, a directional pad, a proximity sensor, and/or any additional sensor which detects information of the input module 240 repositioning. The position sensor can be an analog or digital position sensor. The information of the input module 240 repositioning includes position data. The position data can include one or more coordinates corresponding to the input module 240 repositioning from one location to another.

As the first input sensor 230 is detecting information of the input module 240 repositioning, a second input sensor 235 can detect for a touch gesture at a top surface of the input module 240. The second input sensor 235 is a hardware component of the input device 200 which detects information of a touch gesture at a top surface of the input module 240. The information of the touch gesture can include touch data of the user 205 touching one or more locations of the surface of the input module 240. As shown in the present embodiment, the top surface of the input module 240 can include a flat elongated surface. In one embodiment, the second input sensor 235 is a touchpad, a touch screen, and/or any additional touch sensitive surface which can be coupled to the top surface of the input module 240. In other embodiment, the second input sensor 235 can include any additional sensor which can detect a touch gesture.

As shown in FIG. 2B, a user 205 can access the input module 240 through a gesture 290, such as a hand gesture and a touch gesture. For the purposes of this application, a hand gesture includes a finger and/or a hand of the user touching and repositioning the input module 240 along an axis. In one embodiment, when repositioning along an X axis and/or Y axis, the hand gesture can reposition the input module 240 laterally and the input module 240 repositions substantially parallel to the top surface of the chassis 280. Additionally when repositioning along a Z axis, the hand gesture can reposition the input module 240 vertically by pressing down on the input module 240. The first input sensor 230 detects position data of the input module 240 repositioning.

The user 205 can also use a finger to make a touch gesture at the top surface of the input module 240. When making the touch gesture, a finger of the user 205 can touch or be within proximity of the top surface of the input module 140. As the finger is touching or within proximity, the user 205 can reposition the finger over the top surface of the input module 240. In one example, when repositioning the input module 240 with gestures, the user 205 can use a thumb and middle finger to grasp and reposition the input module 240. While the input module 240 is being repositioned, the index finger of the user 205 can touch and reposition over the surface of the input module 240. In another example, the user 205 can use a first hand to reposition the input module 240 and a finger on the second hand of the user 205 can be used to make touch gestures over the surface of the input module 240.

The first input sensor 230 can detect position data of the input module repositioning in parallel of the second input sensor 235 detecting touch data of the hand gesture. The position data and the touch data from the first input sensor 230 and the second input sensor 235 are shared in parallel of one another with a controller of the device 200. The position data is received by the controller as a first input signal for a computing device. The touch data is received by the controller as a second input signal for a computing device. In one embodiment, the position data and the touch data are received in parallel of one another by the controller. In another embodiment, even though the position data and the touch data are shared in parallel, they are received by the controller sequentially. In response to receiving a first input signal and a second input signal, the computing device can identify one or more input commands associated with the hand gesture and/or the touch gesture.

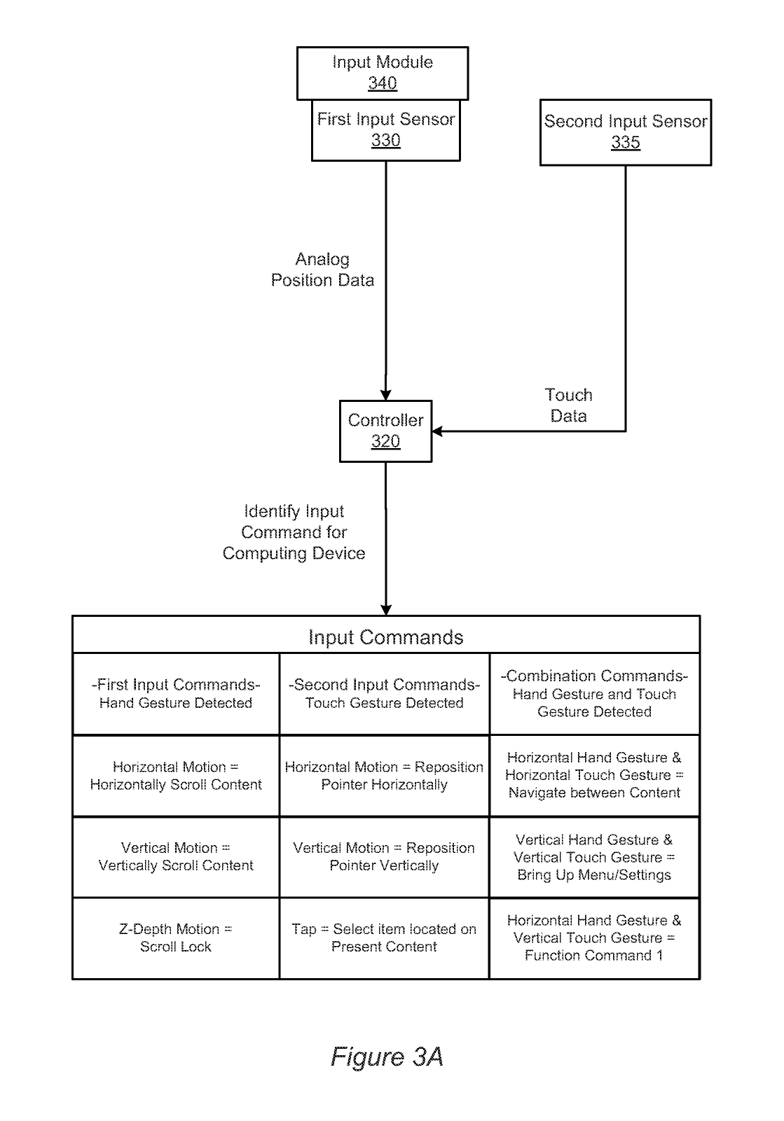

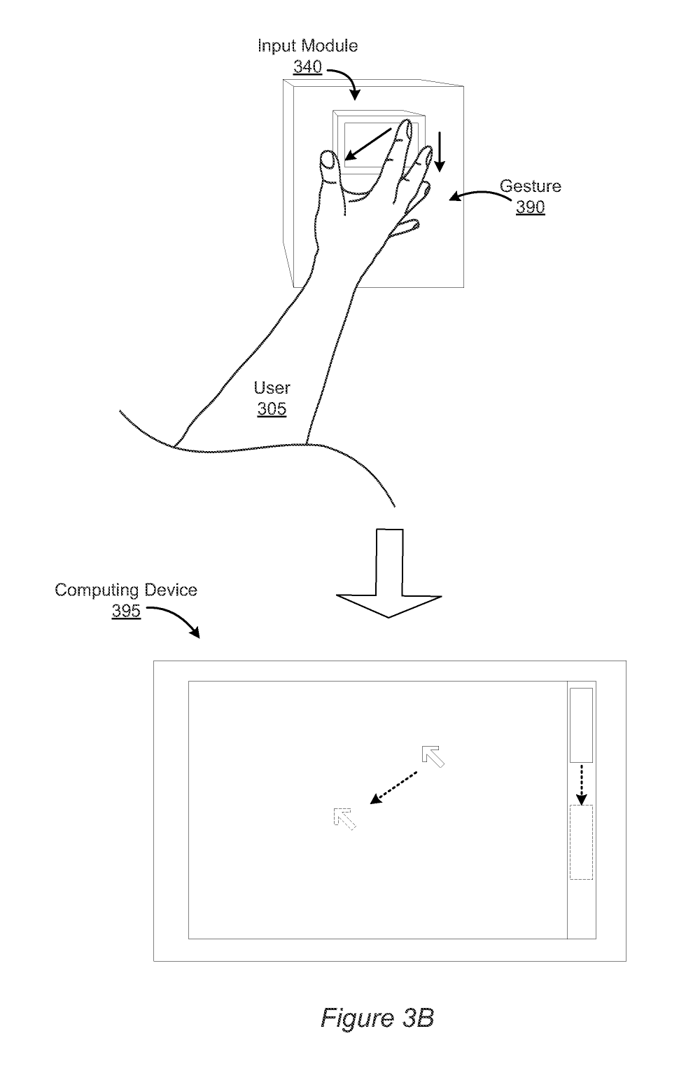

FIG. 3 illustrates a block diagram of a controller 320 receiving input signals for a computing device according to an example. As shown in FIG. 3, a first input sensor 330 has detected an input module 340 repositioning and the second input sensor 335 detects a touch gesture at a surface of the input module 340. In response, the controller 320 receives position data as a first input signal from the first input sensor 340 in parallel of receiving touch data as a second input signal from second input sensor 335. As noted above, the input device can be integrated with the computing device. As a result, the controller 320 can be a controller and/or processor of the computing device. Using the received position data and the touch data, the controller 320 proceeds to identify one or more input commands for a computing device.

The controller 320 can access a list, table, and/or database of input commands to compare the first input signal and the second input signal to predefined information corresponding to input commands of the computing device. The list, table, and/or database of input commands can be stored on the computing device or remotely on another device accessible to the computing device. In one embodiment, the list, table, and/or database of input commands can include first input commands and second input commands. The first input command corresponds to a first input command of the computing device associated with the position data from the first input sensor 330. The second input command corresponds to a second input command of the computing device associated with the touch data from the second input sensor 335.

The controller 320 can access the input commands list and compare the position data from the first input sensor 335 to a list of first input commands to determine whether a matching first input command can be found. In one embodiment, a first input command corresponds with a scrolling input command to vertically and/or horizontally scroll a present rendered content of the computing device. The content can include an application, a document, a webpage, and/or media of the computing device. If a matching first input command is identified, the controller 320 can proceed to execute the matching first input command on the computing device.

The controller 320 also compares the touch data from the second input sensor 335 to the list of second input commands to identify a matching second input command. In one embodiment, the second input command corresponds with a pointer input command to reposition a pointer of the computing device and/or to select an item rendered at the location of the pointer. The pointer can include a visual cursor which is rendered on a display component of the computing device. If a matching second input command is identified, the controller 320 proceeds to execute the matching second input command on the computing device.

If the controller 320 identifies both a matching first input command and a matching second input command are identified, the controller 320 executes both the first input command and the second input command in parallel. As a result, both of the input commands can concurrently be executed on the computing device. In another embodiment, the first input command and the second input command can be in different input threads which are executed by the controller 320 sequentially. The controller 320 can alternate back and forth between the two separate input threads and execute portions of the first input command and portions of the second input command from each input thread in rapid succession, such that they appear to be executing in parallel of one another.

In another embodiment, instead of executing both a first input command a second input command, the controller 320 can identify and execute a combination input command associated with the position data and touch data. As shown in FIG. 3, the list, table, and/or database of input commands can include one or more combination commands. A combination command corresponds to an input command of the computing device associated with both the position data from the first input sensor 330 and the touch data from the second input sensor 335. The controller 320 can compare the position data and the touch data to the list of combination input commands to identifying a matching combination input. In one embodiment, a combination command is a navigation input command of the computing device. The navigation input command can be to navigate between content of the computing device and/or to render a menu or settings for display. The menu or settings can correspond to the content or the computing device.

If a match is found, the controller 320 can proceed to execute the combination input command on the computing device. Additionally, if the combination input command is executed, any first input command matching the position data and any second input command matching the touch data is not executed on the computing device. In another embodiment, if a matching combination input command is not identified, the controller 320 proceeds to identify a first input command matching the position data and proceeds to identify a second input command matching the touch data. The matching first input command and the second input command are then executed in parallel of one another on the computing device.

In other embodiments, if the device is a peripheral input component of the computing device, the controller 320 can share the first input and the second input with the computing device. The computing device can use information of the first input and the second input to identify a first input command, a second input command, and/or a combination input command associated with the hand gesture repositioning the input module 340 and the touch gesture at the surface of the input module 340.

FIG. 3B illustrates a computing device 395 executing input commands in response to a user 305 accessing an input module 340 according to an example. As shown in FIG. 3B, a gesture 390 from the user 305 repositions the input module 340 vertically down while a finger of the user 305 repositions diagonally down and to the left over the surface of the input module 340. The position data is shared as a first input signal and the touch data is shared as a second input signal for a controller and/or a computing device 395 to identify one or more input commands. The controller and/or computing device 395 determines that the first input signal corresponds to a first input command to vertically scroll down and the second input signal corresponds to a second input command to reposition a pointer of the computing device 395 to the lower left. The computing device 395 executes the first input command and the second input command in parallel and/or in rapid succession one another. As a result, the scroll bar of the computing device 395 scrolls downward in parallel of the pointer of the computing device 395 repositioning to the lower left.

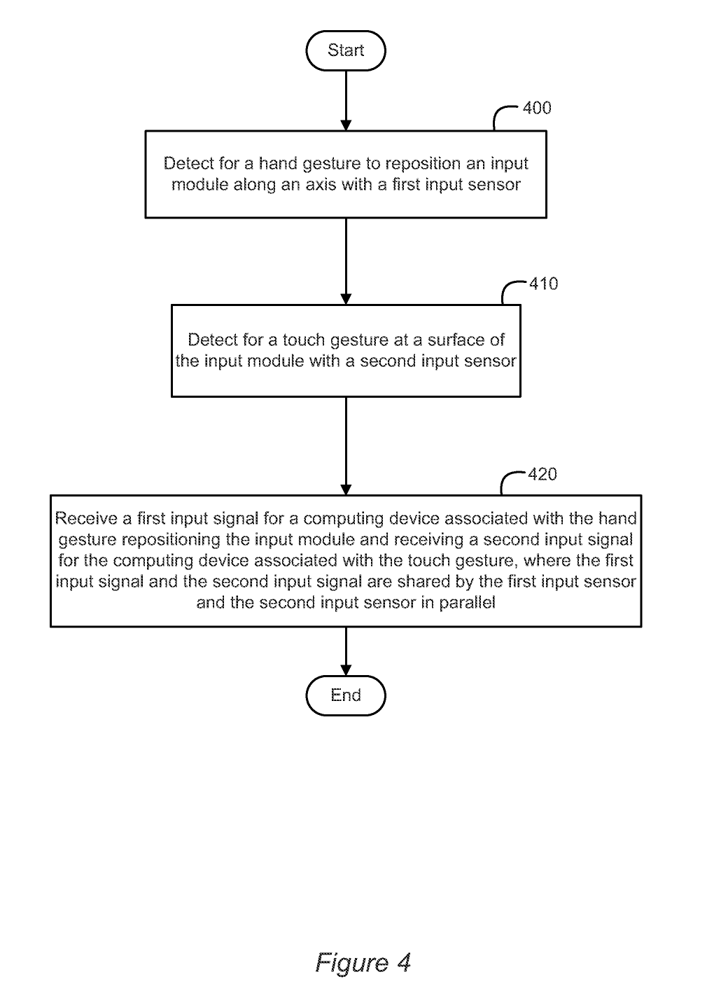

FIG. 4 is a flow chart illustrating a method for detecting an input for a computing device according to an example. A controller can be utilized to identify an input command for a computing device. A first input sensor of the input device, such as a position sensor, detects for a hand gesture to reposition an input module of the input device along an axis at 400. A second input sensor, such as a touch pad, detects for a touch gesture at a surface of the input module at 410. The controller receives a first input signal for a computing device associated with the hand gesture repositioning the input module and receives a second input signal for the computing device associated with the touch gesture at 420. As noted above, the first input signal is transmitted in parallel of the second input signal to the controller. In other embodiments, the method of FIG. 4 includes additional steps in addition to and/or in lieu of those depicted in FIG. 4.

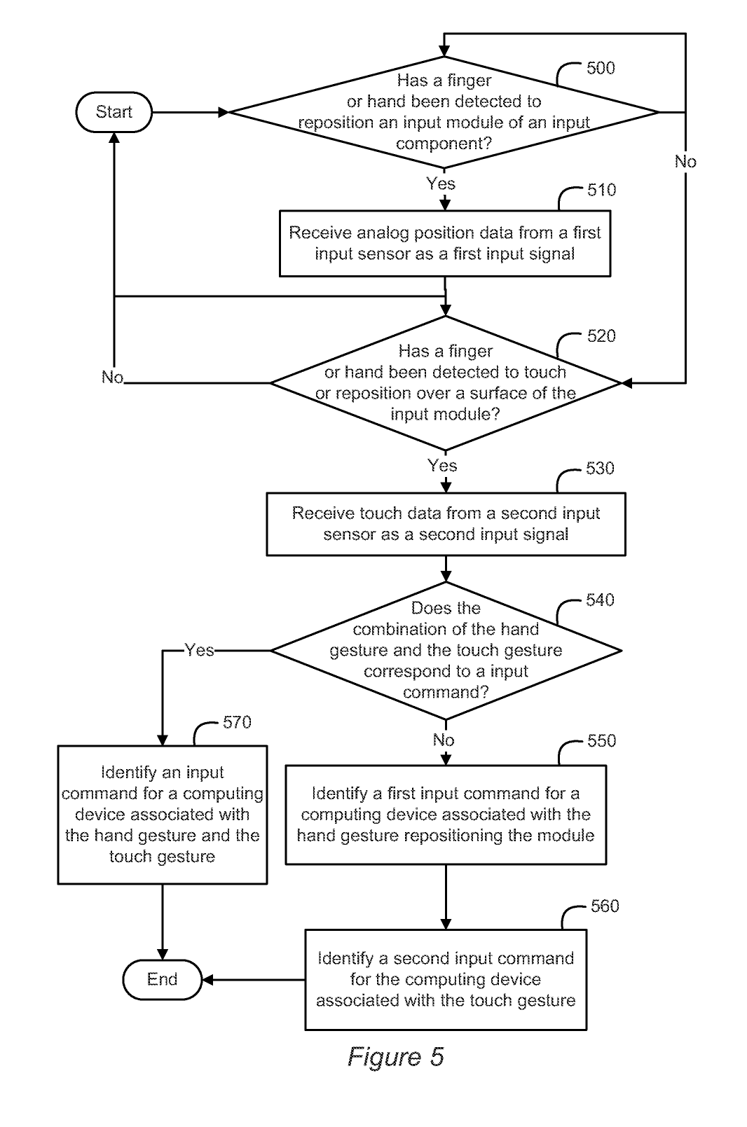

FIG. 5 is a flow chart illustrating a method for detecting an input for a computing device according to an example. A first input sensor of the input device can detect for a finger or hand repositioning an input module at 500. If the first input sensor does not detect the input module repositioning, the first input sensor continues to detect for the input module repositioning at 500. In another embodiment, while the first input sensor continues to detect for the module repositioning, a second input sensor detects for a finger or hand repositioning over a surface of the input module at 520. If the input module is detected to reposition, the controller receives position data from the first input sensor as a first input signal for a computing device coupled to the input device at 510. Likewise, if the surface of the input module is detected to be accessed, the controller can receive touch data from the second input sensor as a second input signal for the computing device at 530. The first input signal and the second input signal are shared by the first input sensor and the second input sensor in parallel of one another. In one embodiment, the controller also receives the first input signal and the second input signal in parallel.

The controller can determine if the combination of the first input signal and the second input signal correspond to an input component for the computing device at 540. If the combination of the first input signal and the second input signal correspond to a combination input command, the controller can execute the combination input command on the computing device at 570. In another embodiment, if the combination of the first input signal and the second input signal do not correspond to an input command for the device, the controller can identify a first input command for the computing device associated with the hand gesture repositioning the input module at 550. The controller can also identify a second input command for the computing device associated with the touch gesture at 560. The first input command and the second input command can be perceived to be executed in parallel of one another. The method is then complete. In other embodiments, the method of FIG. 5 includes additional steps in addition to and/or in lieu of those depicted in FIG. 5.

What is claimed is:

1. An input device comprising:
an input module coupled to a chassis of the input device to reposition along an axis;
a first input sensor to detect the input module reposition from a hand gesture;
a second input sensor to detect a touch gesture at a surface of the input module; and
a controller connected to the first input sensor and the second input sensor to receive a first input signal for a computing device if the first input sensor detects the input module reposition and the controller receives a second input signal for the computing device if the second input sensor detects the touch gesture;
wherein the first input signal and the second input signal are sent by the first input sensor and the second input sensor in parallel of one another.

2. The input device of claim 1 further comprising a mechanism to elevate the input module above a top surface of the chassis.

3. The input device of claim 1 wherein the computing device executes in parallel a first input command associated with the first input signal in and a second input command associated with the second input signal.

4. The input device of claim 1 wherein the first input sensor includes at least one of a potentiometer and a position sensor to detect the input module reposition along an axis.

5. The input device of claim 1 wherein the axis includes at least one of an X axis, Y axis, and Z axis.

6. The input device of claim 1 wherein the hand gesture includes at least one of a hand and a finger of a user repositioning the input module along an axis.

7. The input device of claim 1 wherein the second input sensor is a touch pad of the input module.

8. The input device of claim 1 wherein the touch gesture includes a finger of a user repositioning on the surface of the input module.

9. A method for detecting an input for a computing device comprising:
detecting for a hand gesture to reposition an input module of an input device along an axis with a first input sensor;
detecting for a touch gesture at a surface of the input module with a second input sensor; and
receiving a first input signal for a computing device associated with the hand gesture repositioning the input module and receiving a second input signal for the computing device associated with the touch gesture at the surface of the input module;
wherein the first input signal is transmitted by the first input sensor in parallel of the second input sensor transmitting the second input signal.

10. The method for detecting an input for a computing device of claim 9 wherein receiving the first input signal includes receiving position data from the first input sensor.

11. The method for detecting an input for a computing device of claim 9 wherein receiving the second input signal includes receiving touch data of a finger of a user repositioning over the surface of the input module.

12. The method for detecting an input for a computing device of claim 9 further comprising identifying a first input command to scroll a presently rendered content of the computing device associated with the first input signal.

13. The method for detecting an input for a computing device of claim 9 further comprising identifying a second input command to reposition a pointer rendered on a user interface of the computing device, wherein the second input command is associated with the second input signal.

14. The method for detecting an input for a computing device of claim 9 wherein a first input command associated with the first input signal and a second input command associated with the second input signal are executed in parallel of one another on the computing device.

15. The method for detecting an input for a computing device of claim 9 further comprising identifying a combination input command for the computing device based on both the first input signal and the second input signal.

16. The method for detecting an input for a computing device of claim 15 wherein the combination input corresponds to an input command for the computing device to navigate content of the computing device.

17. An input device for a computing device comprising:
a chassis to include a first input sensor and a second input sensor;
an input module coupled to the chassis with a mechanism to elevate the input module above the chassis and for the input module to reposition along an axis;
wherein the first input sensor detects position data of the input module repositioning from a hand gesture;
wherein the second input sensor detects a touch gesture at a surface of the input module; and
a controller to receive a first input signal for a computing device if the first input sensor detects the module reposition and the controller receives a second input signal for the computing device if the second input sensor detects the touch gesture;
wherein the first input signal and the second input signal are transmitted to the controller in parallel by the first input sensor and the second input sensor.

18. The input device of a computing device of claim 17 wherein the mechanism allows the input module to slide along the axis.

19. The input device of a computing device of claim 17 wherein the first input sensor is coupled to the mechanism.

20. The input device of a computing device of claim 17 wherein the second input sensor is coupled to a top surface of the input module.
